(19) United States
(12) Patent Application Publication
(10) Pub. No.: US 2004/0100054 A1
(43) Pub. Date: May 27, 2004

(54) Skateboard with a hologram pattern

(76) Inventor: Lien-Chuan Yang, Taipei (TW)

Correspondence Address: DENNISON, SCHULTZ, DOUGHERTY & MACDONALD, 1727 KING STREET, SUITE 105, ALEXANDRIA, VA, 22314, US

(21) Appl. No.: 10/301,578

(22) Filed: Nov. 22, 2002

(51) Int. Cl. B62M 1/00; B62K 13/00

(52) U.S. Cl. 280/87.042; 280/7.12

(57) ABSTRACT

the skateboard with a hologram pattern is comprised of: a main board, a skid-proof cloth, a pattern layer, a cover layer and two wheels; wherein the pattern layer is the hologram pattern layer, the cover layer is made of transparent plastic material with a serrated surface; the skid-proof cloth is applied on the surface of the main board; and the cover layer covers the pattern layer, the two layers then are combined with the bottom surface of the main board, after combining, the main board is connected with the two wheels. The skateboard provide different patterns in pursuance of the postures of a skating player, this can increase the visual aesthetic sensing on the skateboard.

### BACKGROUND OF THE INVENTION

1. Field of the Invention

The present invention is related to a skateboard with a hologram pattern, and especially to a skateboard on which the pattern can be changed in pursuance of changing of one's viewing angle, this can effectively improve aesthetic sensing, and is suitable for skateboards or the like.

2. Description of the Prior Art

By the fact that a skateboard runs speedily, and needs skill to play, young people are quite fond of it. A conventional skateboard has a planar pattern printed directly on the surface of the skateboard, the pattern is subjected to falling off by stamping and rubbing, and a planar pattern is duller, and is easy to be abandoned by young people who are fond of newness.

In order to get rid of the defects that the pattern is subjected to falling off by stamping, another skateboard structure had been developed. Such skateboard has a main layer made of wood, the upper surface of the main layer is sequentially applied with an ABS fiberglass reinforced plastic buffering layer and a shaped fiberglass reinforced layer, the reinforced layer is directly provided on the external surface thereof with a desired pattern by screen printing, it forms a printed layer slightly relieved from the external surface, the printed layer is applied on the surface thereof with a friction surface to be dried, cured to form a rubbing resisting structural layer.

Although such a structure can get rid of the defects of direct stamping a planar pattern printed on the surface of the skateboard, the pattern is unchanged, it still does not meet the fondness of young people who like newness and variation, thereby it is not ideal. In view of the above stated defects to be eliminated, and a pattern of different style and changeable in pursuance of the postures of a skating player is expected to be provided, so that the skateboard can provide various changing patterns to increase aesthetic sensing of the skateboard, and to give an observer two kinds of vision enjoyment, the inventor of the present invention developed a skateboard after hard study, designing and fabricating for the public, and this is the motive of the present invention.

### SUMMARY OF THE INVENTION

The primary object of the present invention is to provide a skateboard with a hologram pattern; the pattern can be changed in pursuance of changing of one's viewing angle.

To achieve the above object, the skateboard with a hologram pattern of the present invention is comprised of a main board, a skid-proof cloth, a pattern layer, a cover layer and two wheels; wherein the pattern layer is a hologram pattern layer, the cover layer is made of transparent plastic material with a serrated surface; the skid-proof cloth is applied on the surface of the main board; and the cover layer covers the pattern layer, the two layers then are combined with the bottom surface of the main board, after combining, the bottom surface of the main board is connected with the two wheels. The skateboard can make an observer to see different patterns in pursuance of the postures of a skating player and changing of one's viewing angle, this can increase the function of the skateboard.

The present invention will be apparent in its features after reading the detailed description of the preferred embodiment thereof in reference to the accompanying drawings.

### BRIEF DESCRIPTION OF THE DRAWINGS

FIG. 1 is a perspective view showing an embodiment of the present invention;

FIG. 2 is an analytical perspective view showing the elements of the embodiment of the present invention;

FIG. 3 is a side view of the embodiment of the skateboard of the present invention;

FIG. 4 is a partially enlarged sectional view of the embodiment of the present invention;

FIG. 5 is a schematic perspective view showing the skateboard of the present invention with a hologram pattern can show different patterns in pursuance of changing of one's viewing angle.

### DETAILED DESCRIPTION OF THE PREFERRED EMBODIMENT

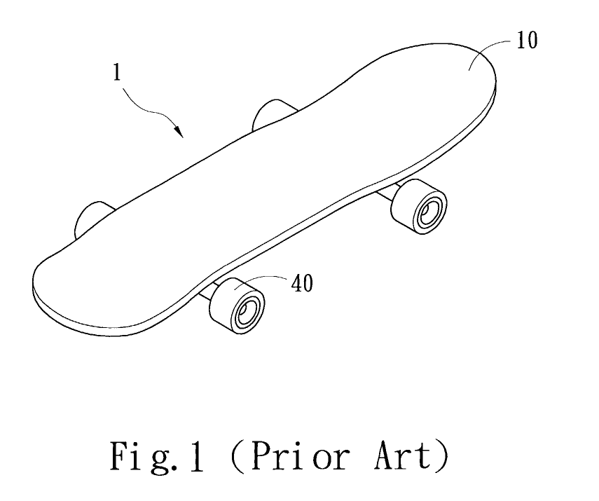

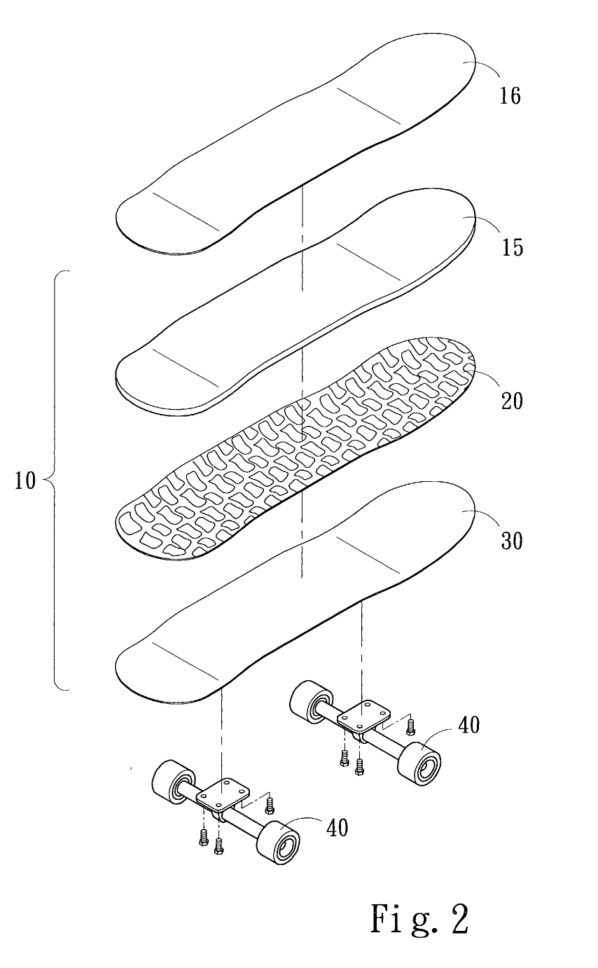

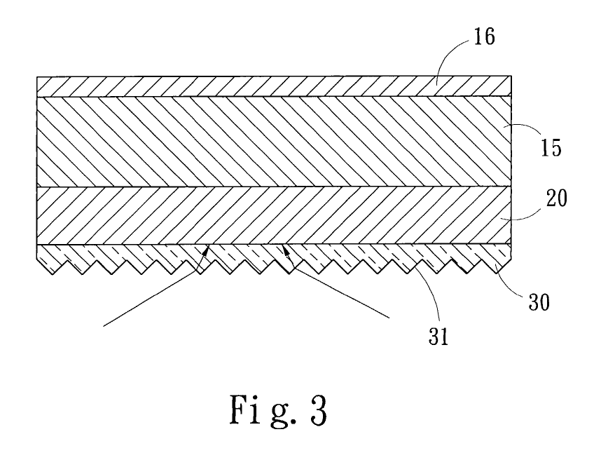

Referring firstly to FIGS. 1, 2, the skateboard 1 of the present invention is comprised of two wheels 40 and a board combination 10, wherein the board combination 10 includes a main board 15 having an elongate arciform surface with a suitable area, the main board 15 has a skid-proof cloth 16 combined with the upper surface thereof, while the bottom of the main board 15 has a pattern layer 20 fixed thereto by covering of a cover layer 30. The pattern on the pattern layer 20 is a hologram formed from two mutual interferent light beams by generating diffraction strips on a photographic paper or a negative. The cover layer 30 is made of transparent plastic material with a serrated surface 31. As shown in FIG. 3, the two wheels 40 are connected onto the bottom surface of the board combination 10 at suitable front and rear locations, and assembling of the present invention is completed.

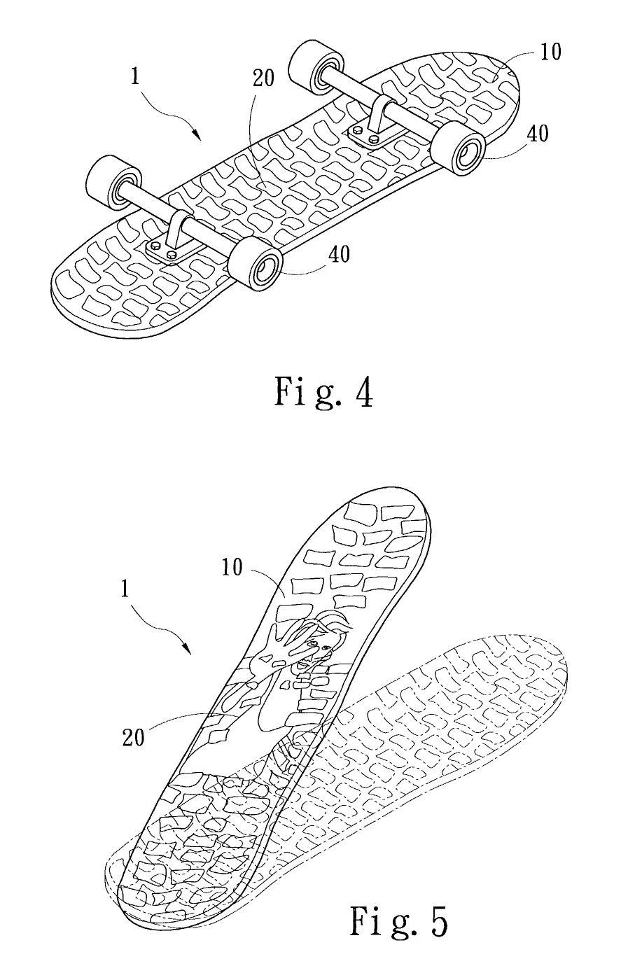

The main board 15 is provided on the surface thereof (that is the stamping surface of the skateboard 1) with the skid-proof cloth 16, hence a player can stand on the skateboard 1 easily. Generally during skating, the skateboard 1 of the present invention is no difference from a conventional skateboard, when the skateboard 1 is used to start figure skating (especially when the skateboard 1 is used to make tossing and turnings), and when the bottom surface of the skateboard 1 can be seen by an observer, by virtue that the pattern layer 20 is a hologram pattern, and the cover layer 30 is provided on the surface thereof with a serrated surface 31, a pattern of an intact brick wall of the pattern layer 20 can be seen during angular changing of the skateboard 1, as shown in FIG. 4; and as shown in FIG. 5, the pattern is changed to that a beauty is getting out by breaking the wall. In this way, when the player makes the actions of turning, jumping etc. during skating, the skateboard 1 can change the pattern in pursuance of the angle of viewing. In addition to allowing the observer to see the skill of the player, the pattern changing on the board combination 10 can also be seen; thereby, the skateboard 1 can provide a rich visual changing effect, and the observer can enjoy two kinds of patterns in vision.

The pattern layer 20 is enveloped by the cover layer 30, and is located on the bottom of the skateboard 1; thereby it can not fall off by stamping.

The structure of the present invention thereby has the following advantages from the above statement:

1. The present invention has an effective style of space arrangement, a user can stand on the skateboard easily by providing the skid-proof cloth; a learner can thereby be convenient to learn skating.

2. The pattern layer is provided on the bottom surface of the skateboard, and is protected by the cover layer, therefore, the user will not directly touch or stamp the pattern layer during skating, the pattern layer thereby can be prevented from stamping by the user and from falling off.

3. The hologram pattern on the pattern layer has the nature of extending sequentially, this leaves an observer an unlimited imaging capability.

In conclusion, according to the above stated contents, the present invention not only can get the expected object thereof to provide a skateboard with a hologram pattern, it is really practicable.

The above stated are only for illustrating the specific embodiment of the present invention, and not for giving any limitation to the scope of the present invention. It will be apparent to those skilled in this art that various modifications or changes can be made, all such modifications and changes also fall within the scope of the appended claims.

1. A skateboard with a hologram pattern comprising:
a board combination including a main board having a skid-proof cloth combined therewith on the upper surface thereof, while the bottom of said main board is combined with a pattern layer and a cover layer; and
two wheels being connected onto the bottom surface of the board combination.

2. A skateboard with a hologram pattern as in claim 1, wherein
said pattern layer on said main board is said hologram pattern.

3. A skateboard with a hologram pattern as in claim 1, wherein
said cover layer on said main board is made of transparent plastic material with a serrated surface.
